(19) United States
(12) Patent Application Publication
(10) Pub. No.: US 2015/0071181 A1
(43) Pub. Date: Mar. 12, 2015

(54) METHOD AND APPARATUS FOR SELECTIVELY ADAPTING BANDWIDTH CONSUMPTION

(71) Applicant: Verizon Patent and Licensing Inc., Basking Ridge, NJ (US)

(72) Inventors: Azim NASIR, Foxboro, MA (US); Dongchen WANG, Concord, MA (US); Andre R. TURNER, Belmont, MA (US); Hong XIAO, Acton, MA (US)

(73) Assignee: Verizon Patent and Licensing Inc., Basking Ridge, NJ (US)

(21) Appl. No.: 14/021,691

(22) Filed: Sep. 9, 2013

(51) Int. Cl. H04W 28/20

(52) U.S. Cl. CPC H04W 28/20; H04W 84/12
USPC 370/329

(57) ABSTRACT

An approach for dynamically adapting bandwidth consumption is described. A token based access platform determines at least one tier of service of a network provider to associate with a request for the use of bandwidth of a wireless access network based on the assignment of a unique token to a user and/or a node associated with the user. The platform then generates, in real-time, an instruction to adapt the amount of bandwidth to be shared by the node associated with the user based on the determination.

### BACKGROUND

Many organizations and business entities (e.g., retailers, restaurants, etc.) offer wireless access as an incentive to attract visitors and potential customers to their physical site location. For example, an owner of a restaurant may offer wireless local area network (LAN), e.g., Wi-Fi, access to visitors so the visitor can readily connect to the Internet via their mobile device while there. Typically, the owner purchases a fixed amount of bandwidth from a network service provider per a network service agreement, which is then shared amongst the visitors who request network access by way of a router and/or combination of other network components. Unfortunately, the owner has little or no capability to control how the bandwidth is shared amongst those requesting access to the network.

Based on the foregoing, there is a need for dynamically adapting bandwidth consumption.

### BRIEF DESCRIPTION OF THE DRAWINGS

The embodiments of the invention are illustrated by way of example, and not by way of limitation, in the figures of the accompanying drawings:

FIG. 1 is a diagram of a system for dynamically adapting bandwidth consumption, according to one embodiment;

FIG. 2 is a diagram of the components of a token based platform of FIG. 1, according to one embodiment;

FIGS. 3A-3C are flowcharts of processes for dynamically adapting bandwidth consumption, according to various embodiments;

FIGS. 4A and 4B are diagrams of user interfaces utilized in the processes of FIGS. 3A-3C, according to various embodiments;

FIG. 4C is a diagram depicting a dynamic adaptation scheme at a location of a provider of a wireless access network, according to one embodiment;

FIG. 5 is a diagram of a computer system that can be used to implement various exemplary embodiments; and

FIG. 6 is a diagram of a chip set that can be used to implement an embodiment of the invention.

### DESCRIPTION OF SOME EMBODIMENTS

Examples of a method, apparatus, and computer program for dynamically adapting bandwidth usage are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

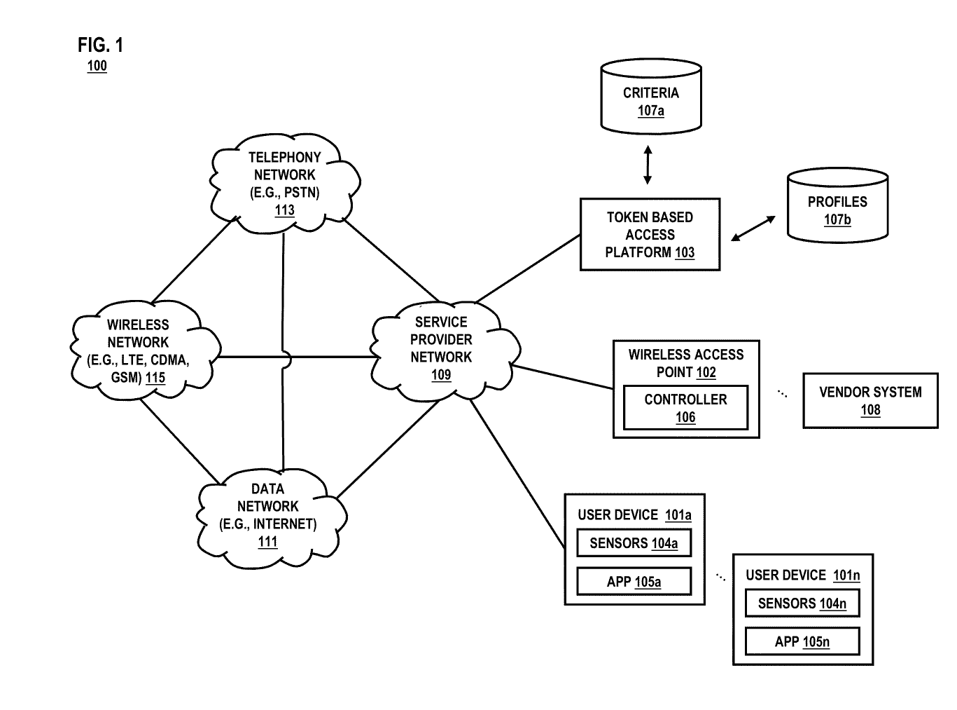

FIG. 1 is a diagram of a system for dynamically adapting bandwidth consumption, according to one embodiment. By way of example, the system 100 includes a token based access platform 103 that is configured to interact with a wireless access point 102 of a provider of a wireless access network. In certain embodiments, the token based access platform 103 may be configured to interact with a vendor system 108, such as a point-of-sale system (POS), a communications platform or any other system for facilitating a transaction between the provider of the wireless access network and one or more users of user devices 101a-101n, referred to herein as user devices 101. User devices 101 may include, for example, mobile devices, smart phones, netbooks, laptops or any other computing devices for wirelessly connecting to and/or accessing a private or public network. The user devices may feature one or more sensors 104a-104n for detecting the network along with one or more applications 105a-105n for communicating over the network.

In modern mobile environments, it is common for retailer or vendors (e.g. cafes, restaurants, bookstores, etc.) and other businesses and organizations to offer wireless network access to requesting users. For example, an organization or business may advertise “Free Wi-Fi” access to mobile device users as a convenience and/or inducement to attract more patrons. The physical site of the business or organization (referred to herein as the provider) may have configured therein a wireless access point, such as a router, a network gateway, etc., that is detectable by a user device 101 at or near said site. Typically, the provider enters into an agreement with a network service provider to facilitate access to a service provider network 109. As note, such agreement may include purchasing a fixed amount of bandwidth from the network service provider, which is to be shared amongst the users who access the wireless network. Unfortunately, the owner is limited in their ability to control how the bandwidth is shared amongst those requesting access. In addition, there is currently no convenient means for dynamically adjusting the bandwidth use of select visitors based on their interaction with the provider (e.g., based on loyalty or purchase history).

To address this issue, the system 100 of FIG. 1 enables providers wireless access networks to dynamically adjust the allocation of bandwidth to select users of mobile devices 101. Still further, the system 100 enables the bandwidth use of the provider to also be adapted dynamically. Hence, under this scenario, the adaptation may include increasing or decreasing the bandwidth made available to requesting mobile devices 101 and/or the wireless access point 102 of the provider. As another example, the adaptation may include enabling or disabling access to the network, i.e., a service provider network 109. The extent to which the bandwidth is adapted may be determined based on a type of token assigned to the node—i.e., the mobile device 101 or wireless access point that requires the bandwidth.

In one embodiment, the token based access platform 103 assigns a token to a requesting node on the basis of an action performed by the node or the user thereof, a status determination associated with the node or the user thereof or the like. In the case of a status determination, the token may correspond to the status and/or type of user and/or node that requires the network access or bandwidth use. For example, a first token for enabling basic access to the network may be assigned to a user that frequents the site location while a second token may be assigned to the provider of the wireless access point 102 pursuant to the service agreement. Hence, the status may pertain to the nature of the business arrangement, relationship or interaction between the provider of the service provider network 109, the provider of the wireless access point 102 and the one or more users of user devices 101 that access the network at any given time.

In addition to the status, assignment of a token may correspond to a given action of a requesting node. The action may include any behavior or task performed as preferred by the provider of the wireless access network (e.g., owner of the wireless access point 102). For example, the behavior or task may include a purchase action or associated purchase amount, completion of a survey, referring of a friend, posting of a favorable endorsement or use of a specific product or brand. As another example, the behavior or task may include a subsequent visit of the user to the provider's site location or execution by the user of a specific type of transaction with respect to the provider. It is noted that the preferred behavior or tasks of the provider may be defined according to one or more criteria 107a. Similarly, the criteria 107a may specify one or more rules, thresholds/measures and metrics for evaluating the action or behavior of a user or the requesting node as well as for determining a status of a given node.

By way of example, the token based access platform 103 may receive data regarding the action performed by the user or a node associated with the user from a vendor system 108. The vendor system 108 may include, for example, a point-of-sales system or other transaction processing system that records and/or generates data regarding an action. While not shown, the vendor system 108 may also include a billing system for enabling the processing of payment credentials, the storing of purchase records, etc. Once recorded or generated per the vendor system 108, the data pertaining to the action is transmitted to the token based access platform 103 for processing.

In one embodiment, processing of the data regarding the action may include determining a particular user or node to associate with the data based on profile information 107b. In addition, the token based access platform 103 may further analyze the data to determine whether the action fulfils the criteria established by the provider. This includes comparing the data against said criteria, determining a level of affinity or correlation between a set of criterion and the data, mapping of the data to various metrics or indices, etc. The result of the analysis may include determining a yes or no determination as to whether the action or behavior of the user is favorable to the provider as well as a determination of a level of “favorability” or preference for the user or node.

In one embodiment, the criteria 107a may be customized by the provider of the wireless access point 102 for use in different organizational, business and usage contexts. For example, in the case of a coffee shop that offers wireless access to customers, a purchase of X dollars may be deemed a more favorable customer action than completing a satisfaction survey or a purchase of only Y dollars. As another example, in the case of a library, donating a book to the library catalogue may be deemed a more valuable action than checking out a book. Still further, in the case of a small business that offers wireless network access via a service provider network 109, a service agreement may further define criteria for specifying a more favorable rate of consumption of bandwidth by the small business. It is noted that the token based access platform 103 may feature a configuration interface for enabling user configuration of the criteria 107a. Per this interface, in certain instances, a scoring of said actions and/or criteria may be applied for enabling the token based access platform 103 to value a given action.

In one embodiment, a favorable result causes the token based access platform 103 to generate and subsequently assign a token to the user, such as for use by a user device 101 or the wireless access point 102. Assignment of the token may include, for example, transmission of the token to the requesting node upon determining fulfilment of the criterion (e.g., execution of a preferred behavior or action of the requesting node or user). The transmission may occur via a known data transmission protocol such as near-field communications (NFC). Alternatively, the token may be conveyed visually to the user for manual entry/activation. Under this scenario, the vendor system 108 may feature an interface to the token based access platform 103, i.e., per an application programming interface (API), for enabling conveyance of an assigned token. As such, the token may be printed onto a receipt or presented to a display of the vendor system 108 pursuant to a purchase by the user. It is noted that the exemplary embodiments may support any means of issuance and/or conveyance of the token.

In one embodiment, the type of token assigned varies according to the level of favorability of the action performed. The token, which may be implemented according to any known security and/or authentication scheme, may correspond to a specific tier of bandwidth for allocation to the requesting node. For instance, a token may be assigned to the wireless access point 102 for accessing a specific tier of bandwidth of the service provider network 109. Alternatively, the token may be assigned to a select user device 101 for affecting a tier of bandwidth made available by the wireless access point 102. Under this scenario, the type of token assigned dictates the amount of bandwidth available to the requesting node as well as which tier of service is available.

Still further, the token may be generated according to a limited period of validity. The period of validity may correspond to a timeframe in which the token and may be actively used to enable the accessibility of the assigned tier of bandwidth. Under this scenario, the period of validity is assigned at the time of token generation and is based on the extent to which the requesting node or user meets the criterion. For example, the period of validity may be based on the action performed by the user, the status of the user and/or the execution of subsequent tasks by the user. As such, in addition to the type of token being dynamically adapted relative to the actions of the user, the period of validity of the token may be adapted as well. A use case scenario is described herein for presenting different token generation and issuance schemes for different users of a first, second and third mobile device.

Under this scenario, the device users are regular customers of a local coffee shop that offers Wi-Fi access to its patrons. Hence, all three users have access to the same wireless access network, wherein no token is required for enabling such access. This may correspond to a basic level of bandwidth use for the different devices, which corresponds to a shared partitioning of the bandwidth among all of the users of the network within the coffee shop at the given time. However, per the token based access platform 103, the wireless access network at the coffee shop may be configured to provide additional bandwidth to select users based upon purchase amount or purchase activity. This criterion is established by the provider of the wireless access network, i.e., the owner or manager of the coffee shop, such as by way of a configuration interface of the token based access platform 103.

At various times during the visit to the coffee shop, the users may purchase one or more goods. For instance, the user of the first mobile device purchases coffee and a pastry for $8. This activity is recorded by the point-of-sale system of the vendor and provided as feedback to the token based access platform 103. Similarly, the users of the second and third mobile devices make purchases totaling $5 and $3 respectively via the POS system, which is also reported to the token based access platform 103. In response, the token based access platform 103 analyzes the purchase data to determine whether the purchase fulfills criteria established by the vendor. In this example, the criteria set forth specifies that any user spending more than $7 is issued a network access token that affords them bandwidth/speeds up to X bits per second for a period of validity of X hours (e.g., premium access). The criteria further specifies that any user spending more than $15 dollars is issued a network access token that affords them even higher bandwidth/speeds up to Y bits per second for a period of validity of Y days (e.g., premiere access). Purchase activity below these established thresholds warrants only the basic/free wireless network access, wherein the speed is variable and dependent upon the number of users at the coffee shop at any given time.

Based on the analysis, the token based access platform 103 determines that the first user's purchase exceeds the $7 threshold, while the second and third mobile device users' purchases fall below the thresholds for higher bandwidth (e.g., premium or premier access). Resultantly, the platform 103 generates and assigns the user of the first mobile device a token corresponding to X bits per second for a period of validity of X hours (e.g., premium access) while the second and third mobile device users are relegated to variable bandwidth use (e.g., free/basic access). The token as generated for the user of the first mobile device may be printed onto the receipt as a code, symbol or the like for entry and/or scanning for accessing the wireless access point of the vendor. Alternatively, depending on the capabilities of the POS system at the coffee shop, the token may be electronically transmitted to the first mobile device by way of a short-range communication protocol (e.g., near field communication), short messaging service or email.

In the latter case, the user may subsequently pass the token electronically to the wireless access point, e.g., via touch based communication or display the token at the POS for activating usage of the token. In either case, as long as the user of the first mobile device is within proximity of the wireless access point of the coffee shop and activates the token for use within X hours, they may enjoy the higher bandwidth use. In contrast, the users of the second and third mobile devices, while having access to the network, have limited bandwidth use. Depending on the requirements of the vendor, the bandwidth at the basic/free tier may be throttled down to allow Internet access but without video playback or large media consumption.

Per this example, it is noted that each threshold established as criterion may correspond to a different tier of bandwidth use; with the various bandwidth ranges at each tier capable of being customized by the vendor. In addition, the vendor may specify the type of action to be performed for warranting access to a specific tier as well as the name of a given tier. For example, the vendor may specify that the different tiers be labeled basic, premium and premier. Still further, the token based access platform 103 may be configured by the vendor to present messages to the users regarding their level of activity and/or regarding the fulfillment of criteria. Under this scenario, a message may be printed to the receipts of the users of the first and second mobile devices for indicating that purchases over $7 and $15 would garner higher rates of bandwidth. As another example, the message may specify that if they spend enough to at least meet the criteria for premium access within the next hour, they may be incented with token access for achieving the premier tier of access.

Per the above described scenario, a vendor subscribed to the token based access platform 103 is able to customize the access levels they make available to users. In addition, the vendor is able to dynamically control bandwidth use for select users on the basis of desired actions. As such, the vendor may incent users to take actions that are favorable to the business, associated the bandwidth tiers with specific marketing messages and/or campaigns and drive ups-selling opportunities. It is noted, however, that the established maximum bandwidth use of the vendor (as accessed by the wireless access point 102) may further be dynamically adapted based on the activity of the vendor. For instance, in the case where the bandwidth use by the vendor is determined to exceed the agreed upon bandwidth threshold (e.g., a higher than usual number of premier access users are consuming bandwidth at the store), the wireless access point may be assigned and subsequently activate a token for user of a next level tier of bandwidth of the network service provider. Hence, the token based access platform 103 may interact with the wireless access platform 103 and/or vendor system 108 to receive data for specifying system level activity; thus enabling accommodation of the higher bandwidth needs of the overall coffee shop at any given moment.

It is noted, per the above described embodiments, that different nodes may be assigned different tokens. Consequently, the different nodes may be assigned different tiers of service within the same wireless access network. As such, the wireless access point 102 may interact with the token based access platform 103 to throttle the bandwidth up or down with respect to a given user device 101 according to the assigned token type/value. This is in contrast to traditional approaches of bandwidth allocation or management, wherein the ability to throttle the bandwidth is not selective but rather limited to only the wireless access point 102 or requires a direct limiting of consumption at the user device 101 itself.

In one embodiment, the token based access platform 103 is configured to interact with the wireless access point 102 by way of a controller module 106. The controller module 106 may be implemented as a software based module, hardware based module, or a combination thereof for operation at the wireless access point 102 for receiving and processing instructions received from the platform 103. The instructions may include a command to adapt (e.g., throttle up or down) the amount of bandwidth to be used by a specific node, i.e., a user device connected to the wireless access point 102, in response to analysis of a token presented. It is noted therefore that the wireless access point 102 (e.g., router or network gateway) will be able to communicate with the upstream network infrastructure in order to dynamically increase the bandwidth allocations based on real time demand. Furthermore, the wireless access point is able to increase/decrease bandwidth allocation by way of token generation/invalidation messaging from the wireless access point 102 via the controller 106 to the upstream network components (e.g., as per the service provider network 109).

In one embodiment, the token based access platform 103 may be implemented as a managed or hosted solution or platform configured to generate tokens for enabling dynamic adaptation of bandwidth use by a user and/or node associated therewith. For example, the platform 103 may be a cloud based solution that is insulated from but able to securely communicate with the vendor system 108. Alternatively, the token based access platform 103 may be distinct from the cloud infrastructure, but accessed via the cloud for facilitating the retrieval of data regarding user activity. Regardless of the implementation, the platform 103 may be configured to maintain profiles 107b regarding one or more registered users. The profiles 107b may therefore include those of the providers of the wireless access points 102 (e.g., vendors) configured to interact with the platform 103 by way of a controller module 106. Alternatively, the profiles 107b may correspond to users that visit, purchase from or otherwise interact with the provider of the wireless access point 102 (e.g., as customers). Under this scenario, the profiles 107b may be maintained securely and anonymously such that the personal information associated with a user is maintained confidentially.

To the extent the aforementioned embodiments collect, store or employ personal information provided by the users of devices 101a-101n, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In certain embodiments, user devices 101a-101n, the token based access platform 103 and other elements of system 100 may be configured to communicate via a service provider network 109. According to certain embodiments, one or more networks, such as data network 111, telephony network 113, and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network.

Networks 109-115 may employ various technologies for enabling wireless communication including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Still further, a communication provider network (e.g., networks 109 and 113) may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, the communication network may embody or include portions of a signaling system 7 (SS7) network, Internet protocol multimedia subsystem (IMS), or other suitable infrastructure to support control and signaling functions.

It is noted, though not shown in the figure, that in certain embodiments user devices 101a-101n may be configured to establish peer-to-peer communication sessions with each other using a variety of technologies—near field communication (NFC), Bluetooth, ZigBee, infrared, etc. Also, connectivity can be provided via a wireless local area network (LAN). By way of example, a group of user devices 101a-101n may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101, i.e., IP addresses that are accessible to devices connected to the service provider network 109 as facilitated via a router.

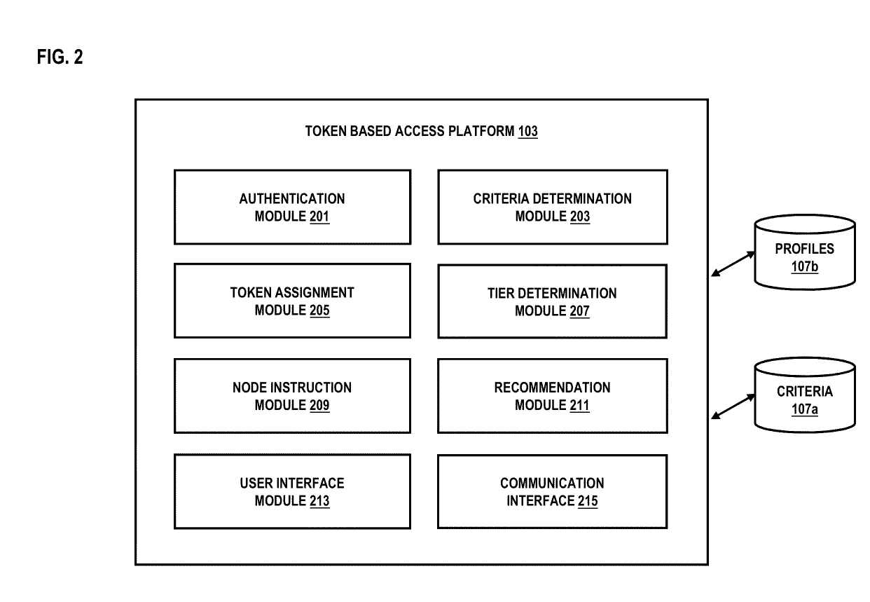

FIG. 2 is a diagram of the components of a token based access platform of FIG. 1, according to one embodiment. It is contemplated that the functions of these components may be combined in one or more components or performed by other components of equivalent functionality. Such modules can be implemented in hardware, firmware, software, or a combination thereof. By way of example, the token based access platform 103 may include an authentication module 201, criteria determination module 203, token assignment module 205, tier determination module 207, node instruction module 209, recommendation module 211, user interface module 213 and communication interface 215.

In addition, the token based access platform 103 also accesses profile data 107b from a profile database 107, the database maintaining information pertaining to users (e.g., customers or patrons) that interact with one or more subscribed providers of wireless access networks (e.g., vendors). The profiles 107b may also correspond to the providers subscribed to the token based access platform 103. Also, the token based access platform 103 may also access criteria 107a associated with a subscribed provider that specifies one or more rules, conditions, thresholds, requirements or the like to be fulfilled for supporting conditional, tier based bandwidth use. It is noted that modules 201-215 may access the various databases 107a and 107b for performing several of its functions.

In one embodiment, an authentication module 201 authenticates users, i.e., providers of a wireless access network, for interaction with the token based access platform 103. By way of example, the authentication module 201 receives a request from a user to subscribe to the service for supporting interaction between a wireless access point 102 of the provider and the token based access platform 103. The subscription procedure may include establishing a profile 107b as well as activating a controller 106 at the wireless access point 102.

The authentication process performed by the module 201 may also include receiving and validating a login name, user identification value or node identifier as provided or established during a subscription or registration process. The identification value may be received as input from the user via a graphical user interface to the platform 103 (e.g., as enabled by user interface module 213). Registration data for respective subscribers, which contains pertinent user or device profile data, may be cross referenced as part of the login process. Alternatively, the login process may be performed through automated association of profile settings maintained as registration data with an IP address, a carrier detection signal of a user device, mobile directory number (MDN), subscriber identity module (SIM) (e.g., of a SIM card), radio frequency identifier (RFID) tag or other identifier.

In one embodiment, the criteria determination module 203 is configured to correlate data regarding an action taken by a user or a node associated with the user with established criteria of a provider of the wireless access network. The action may include a preferred behavior or task as performed with respect to the provider (e.g., owner of the wireless access point 102). For example, the behavior or task may include a purchase action or associated purchase amount, completion of a survey, referring of a friend, posting of a favorable endorsement or use of a specific product or brand by a customer. Once received, such as from a POS system associated with the provider of the wireless access point, the criteria determination module 203 accesses the criteria 107a associated with the profile 107b of the in question.

Still further, the criteria determination module 203 analyzes the data to determine whether the action fulfils the criteria 107a established by or for the provider. By way of example, the analysis includes comparing the data against said criteria 107a, determining a level of affinity or correlation between a set of criterion and the data, mapping of the data to various metrics or indices, etc. The result of the analysis may include determining a yes or no determination as to whether the action or behavior of the user is favorable to the provider. In addition, the criteria determination module 203 may determine a level of favorability of the action, thus associating a score with the action. The score may subsequently be provided to the tier determination module 207, which in certain embodiments determines a tier of bandwidth to assign to the user or node responsible for the action. It is noted that the tiers may be predefined by a provider of a service provider network 109 or established by the provider of the wireless access network.

In one embodiment, the token assignment module 205 generates and/or assigns a token to a requesting node in response to the results returned by the criteria determination module 203. The token is assigned on the basis of the action performed by the node or the user thereof, a status determination associated with the node or the user thereof or the like. In the case of a status determination, the token may correspond to the status and/or type of user and/or node that requires the network access or bandwidth use. Generation of the token may also include establishing of a period of validity of said token. The period of validity may include a number of hours, days, etc., in which the token and thus the corresponding bandwidth tier is available for use. Once generated, the token is transmitted to the corresponding user or node, presented to the user or corresponding node, or a combination thereof.

In one embodiment, the node instruction module 209 is configured to generate instructions for affecting operation of the wireless access point based on the assigned token per the token assignment module 205. The instructions may include a command to adapt (e.g., throttle up or down) the amount of bandwidth/speed used by a specific node. Another instruction may include restricting the bandwidth use entirely for a given user. It is noted that the instructions are received by the controller module 106 that operates in connection with the wireless access point 102.

In another embodiment, the recommendation module 211 may be configured to generate messages for specifying a recommendation, a current mode of use, an incentive or offer or any instruction to be associated with a user or node based on the assigned token. By way of example, the recommendation may include a suggested action for the user to take in order to receive a token that is valid for higher bandwidth use. As another example, a marketing message for up-selling the user on the basis of their most recent purchase may be presented. It is noted that the message may be conveyed to the user as a text message, as a web based communication, an email or the like.

In one embodiment the user interface module 213 enables presentment of a graphical user interface for rendering a registration interface or configuration interface of the token based access platform 103. By way of example, the user interface module 213 generates the interface during registration of a user or service provider for access to the platform 103. The user interface module 213 may initiate the execution of various application programming interfaces (APIs) or other function calls corresponding to the controller module 106 of the wireless access point 102, i.e., for displaying graphics primitives.

In one embodiment, a communication module 215 enables formation of a session over a network 109 between the token based access platform 103 and the controller 106. By way of example, the communication module 215 executes various protocols and data sharing techniques for enabling collaborative execution between a user device 101a-101n (e.g., mobile devices, laptops, smartphones, tablet computers, desktop computers) and the token based access platform 103 over the network 109.

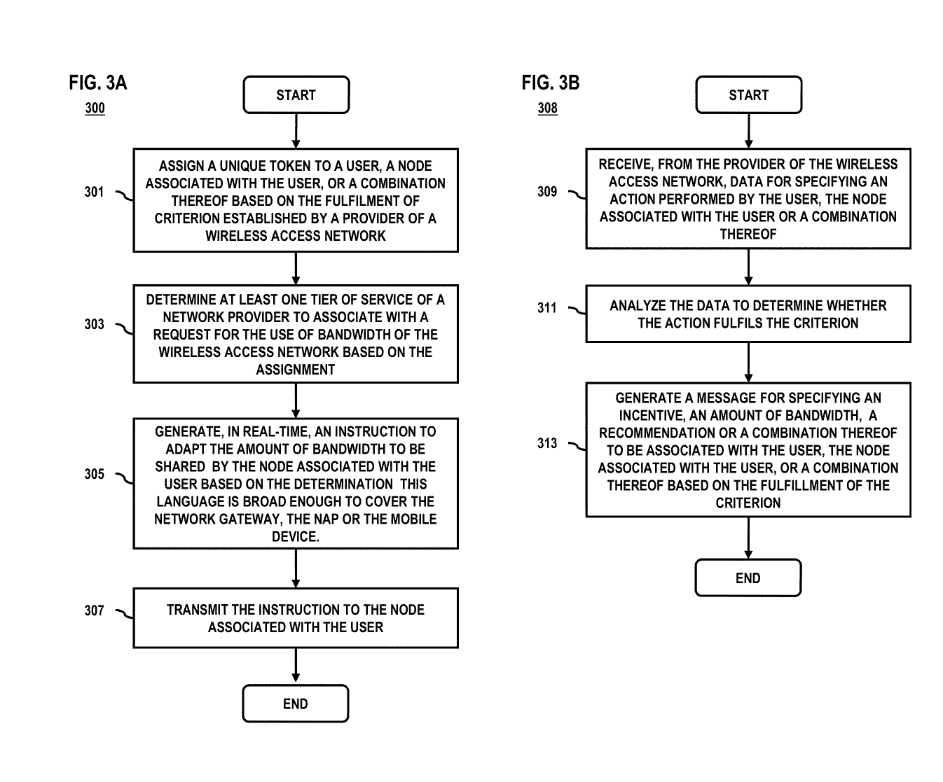

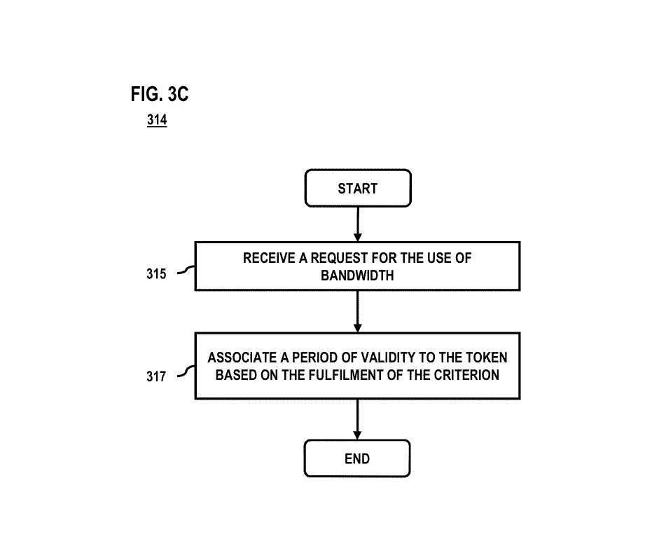

FIGS. 3A-3C are flowcharts of processes for dynamically adapting bandwidth consumption, according to various embodiments. In one embodiment, the token based access platform 103 performs the processes and is implemented in, for instance, a chip set including a processor and a memory as shown in FIG. 11. For the purpose of illustration, the processes are described with respect to FIG. 1. It is noted that the steps of the processes may be performed in any suitable order, as well as combined or separated in any suitable manner.

In step 301 of process 300, the token based access platform 103 receives a first request from a user for an estimate for a service assigns a unique token to a user, a node associated with the user, or a combination thereof based on the fulfilment of criterion established by a provider of a wireless access network. As noted previously, the criterion may include transaction information (e.g., purchase type or quantity of product purchased), user information (e.g., number of visits, duration/history/loyalty, membership status, customer standing), product information (e.g., brand, manufacturer), business rules, a service agreement or a combination thereof. The criteria is established for use in determining whether an action or behavior of a user or node requiring bandwidth meets a predetermined standard/is indicative of a preferable action to the provider of the bandwidth.

In step 303, the token based access platform 103 determines at least one tier of service of a network provider to associate with a request for the use of bandwidth of the wireless access network based on the assignment. As mentioned previously, the tier of service may be defined at the level of the provider of a service network or alternatively, by the provider of a wireless access point. As such, the allocation of the bandwidth may be customized directly by the provider of the wireless access network or regulated by the provider of the service provider network 109 per a service agreement.

In step 305, the token based access platform 103 generates, in real-time, an instruction to adapt the amount of bandwidth to be shared by the node associated with the user based on the determination. In another step 307, the platform 103 transmits the instruction to the node associated with the user. It is noted that the instruction may include a request to increase or decrease the bandwidth in accordance with the identified tier. The token based access platform 103 may interface with the node by way of an application programming interface, controller 106 or the like associated configured for operation at the node.

In step 309 of process 308 (FIG. 3B), the token based access platform 103 receives, from the provider of the wireless access network, data for specifying an action performed by the user, the node associated with the user or a combination thereof. By way of example, the data may be information generated by a point-of-sales system, a billing system, a vendor system or a combination thereof associated with the provider of the wireless access network. In step 311, the platform 103 analyzes the data to determine whether the action fulfils the criterion. As noted previously, the assigning of the token is based on the analysis.

Per step 313, the token based access platform 103 generates a message for specifying an incentive, an amount of bandwidth, a recommendation or a combination thereof to be associated with the user, the node associated with the user, or a combination thereof based on the fulfillment of the criterion. Under this scenario, the node in question may be a mobile device that displays the message via a browser interface, as a text message or any other communication means.

In step 315 of process 314 (FIG. 3C), the token based access platform 103 receives a request for the use of bandwidth. The request may be initiated by a user device, such as a mobile device of a user. Alternatively, the request may be initiated by the wireless access point of a provider of the wireless access. As mentioned previously, the request may specify an assigned token. In certain instances, the request may be initiated concurrent with the transmission of data regarding the activity of the user—i.e., to initiate automatic assignment and/or login of a user device 101 pursuant to performance of a favorable action. Per step 317, the platform 103 associates a period of validity to the token as assigned based on the fulfilment of the criterion.

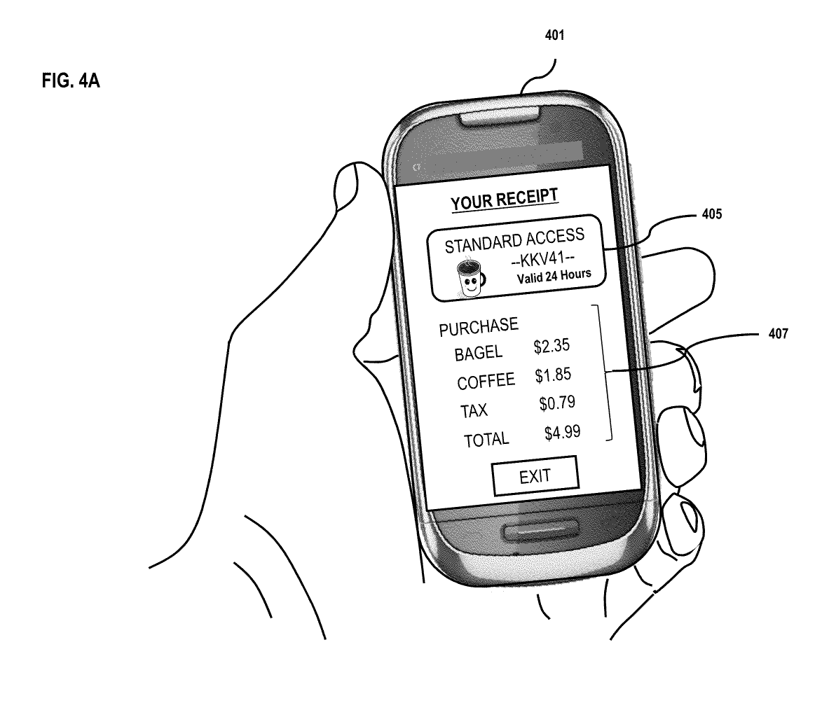

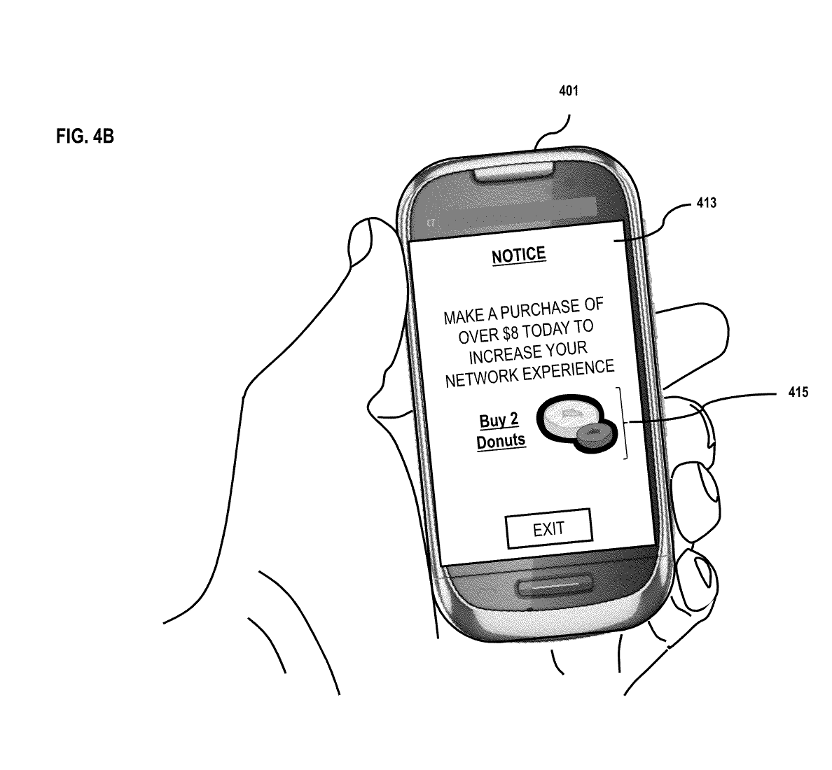

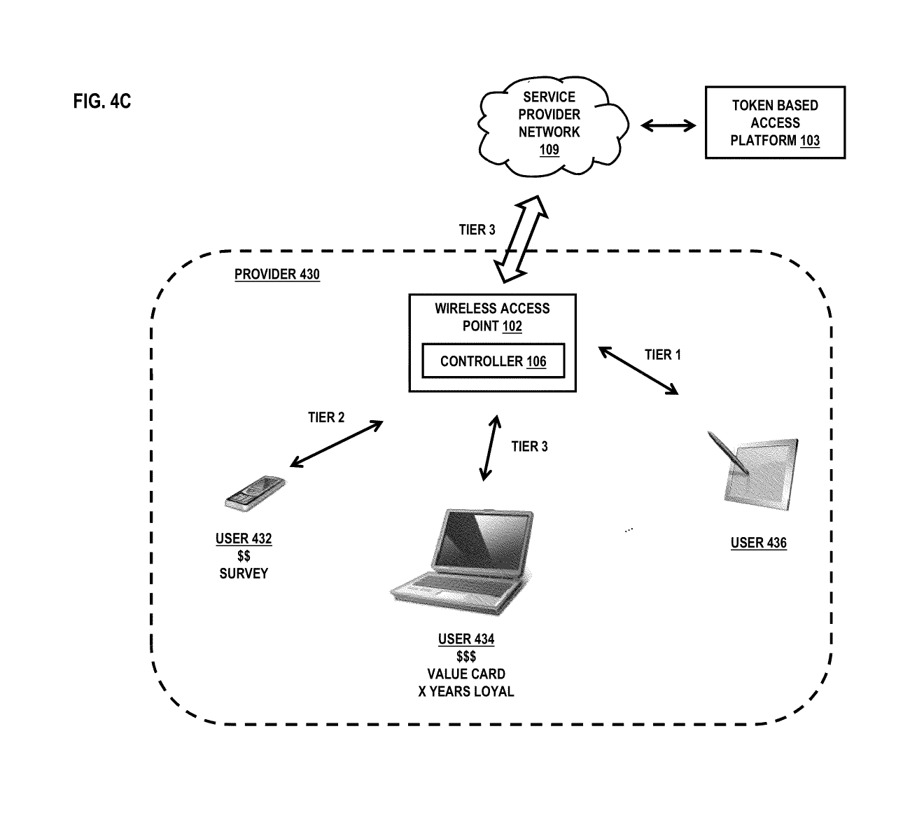

FIGS. 4A and 4B are diagrams of user interfaces utilized in the processes of FIGS. 3A-3C, according to various embodiments. By way of example, the diagrams pertain to interfaces of a user device 401 for enabling a user to receive a token for accessing bandwidth at a certain tier (e.g., range of speed and/or capacity). The tier to which the token correlates corresponds to the determined level of interaction of the user or the user device 401 with the provider.

In FIG. 4A, the user of device 401 visits the physical store location of the provider, which for example purposes is a coffee shop. While there, the user takes advantage of the basic level Wi-Fi access offered by the provider as a convenience to all visitors. As such, the quality of the experience depends on the overall performance of the network, the number of other users connected to the same network and thus consuming the limited bandwidth resources at the coffee shop. In addition to accessing the network, the user also purchases various food items from the shop as performed via a point-of-sale (POS) system at the shop. In response to this action, the POS system submits data regarding the purchase transaction to the token based access platform 103, i.e., via an application programming interface.

The token based access platform 103 performs analysis of the data as well as processes any corresponding profile data associated with the provider and/or user to determine the level of favorability associated with the user's purchase action. For the purpose of illustration, criteria set forth by the provider calls for any purchase actions under $8 to correspond to a second tier of bandwidth, referred to herein as “Standard Access” while higher purchases correspond to a third/higher tier referred to herein as “Super Access.” Hence, based on the analysis and the criteria, the token based access platform 103 assigns to the user a token corresponding to the standard access tier with a limited period of validity and transmits the token to the POS at the café. Under this scenario, the POS then provides the user with a digital receipt corresponding to their purchase transaction, which includes the purchase details 407 as well as a visual representation of the token 405. The token 405 includes, for example, a label for indicating the type of bandwidth access available to the user, a code for representing a unique identifier for enabling bandwidth/network access and the designated period of validity.

In FIG. 4B, a notification message 413 is generated by the token based access platform 103 in response to the purchase action of the user as depicted in FIG. 4A. Under this scenario, the message 413 is a recommendation for the user to make a purchase over $8 dollars so they can qualify for the next bandwidth tier. In addition, the message includes a recommendation of a specific item for the user to purchase to meet the purchase amount threshold, i.e., an up-sell message 415. It is noted that the up-sell message 415 and/or recommendation 413 may be tailored to accommodate known interests and preferences of the user.

FIG. 4C is a diagram depicting a dynamic adaptation scheme at a location of a provider of a wireless access network, according to one embodiment. For the purpose of illustration, the provider 430 is a coffee shop that supports the network access needs of various users 432-436. Each of the users employ different devices for accessing the wireless access point 102 of the provider 430, including a mobile phone, laptop computer and tablet computing device for users 432, 434 and 436 respectively. In addition, each of the users perform different actions within the coffee shop, each action having different levels of favorability as per the token based access platform 103 to which the wireless access point 102 and/or vendor system (not shown) is configured to interact with.

Under this scenario, user 436 performs no favorable actions, such as purchases, and is therefore enabled only tier 1 bandwidth use. This corresponds to the basic/free level of bandwidth use as provided to all visitors of the coffee shop. It is noted that this level of access may be achieved without issuance and/or use of a token by the user 436 of the tablet device.

User 432 purchases a few items as well as conducts a customer satisfaction survey. Based on the analysis of this action by the token based access platform 103 against the criteria established by the provider 430, a token is issued for the user 432 for enabling tier 2 bandwidth use. Resultantly, an instruction is sent by the token based access platform 103 to initiate activation of tier 2 bandwidth use for the cell phone in response to activation of the token by the user 432 within the period of validity.

In the case of user 434, the user makes a sizeable purchase, registers for a frequent shopper value card and is determined to be a loyal customer of over X years. Based on this data, the platform 103 determines that the user qualifies for the highest tier of bandwidth and is therefore issued a token for tier 3 bandwidth use. Given the tier and loyalty of the customer, the period of validity of the token may be for a longer period than the token issued with respect to user 432. Consequently, an instruction is sent by the token based access platform 103 to initiate activation of tier 3 bandwidth use for the laptop computer in response to activation of the token by the user 434 within the period of validity. This may correspond to a throttling up of the bandwidth for only the device of user 434 without impacting the bandwidth use of the devices associated with users 432 and 436. It is noted that this corresponds to the selective and dynamic adjusting of bandwidth use within the wireless access network.

Still further, the bandwidth tier of the wireless access point 102 is dynamically adjusted in response to an increase in the number of visitors/customers at the coffee shop. This adjustment occurs pursuant to an agreement between the provider 430 and a provider of a service provider network 109, wherein the agreement may enable dynamic adjusting of the bandwidth use by the wireless access point 102 in response to the meeting of certain criteria. The criteria may include a certain number of nodes being connected to the wireless access point 102, a certain number of tier 2 and/or tier 3 bandwidth tokens issued, etc. Under this scenario, the bandwidth associated with the wireless access point 102 is throttled up from tier 2 to tier three in response to a determination of one or more criteria being fulfilled. It is noted that in certain implementations, the wireless access point 102 may be issued a token for enabling higher order tier based bandwidth use corresponding to the provider to network service provider level.

The exemplary techniques and systems presented herein enable dynamic adaptation of bandwidth among nodes. In addition, the exemplary techniques and systems enable selective adaptation of said bandwidth, wherein the bandwidth use for different devices may be associated with different tiers accordingly.

The processes described herein for dynamically adapting bandwidth consumption may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

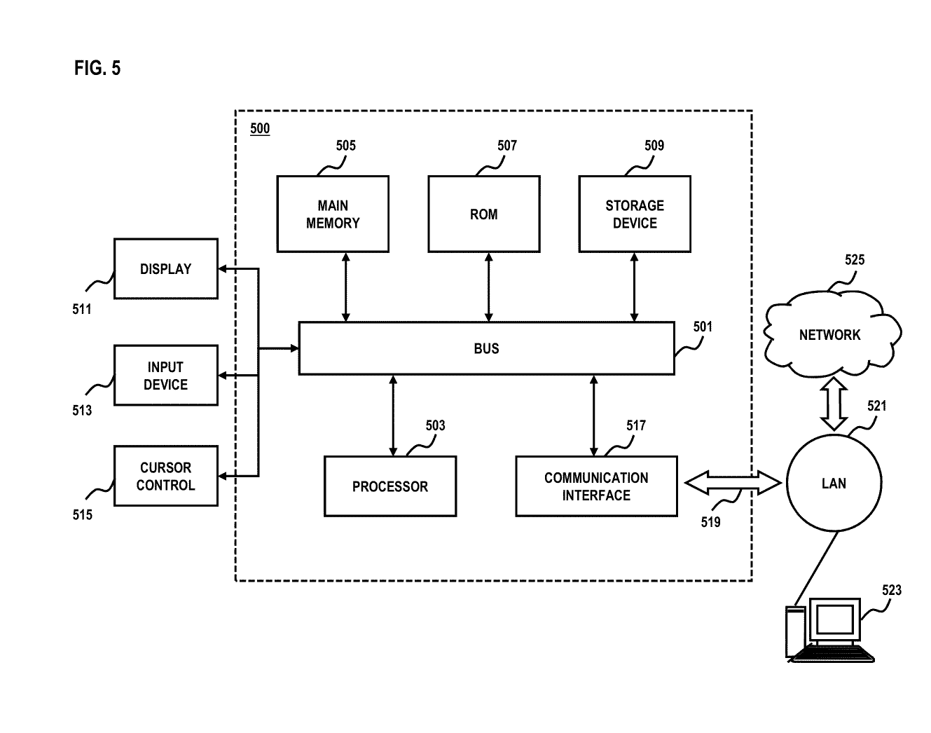

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, light emitting diode (LED) display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

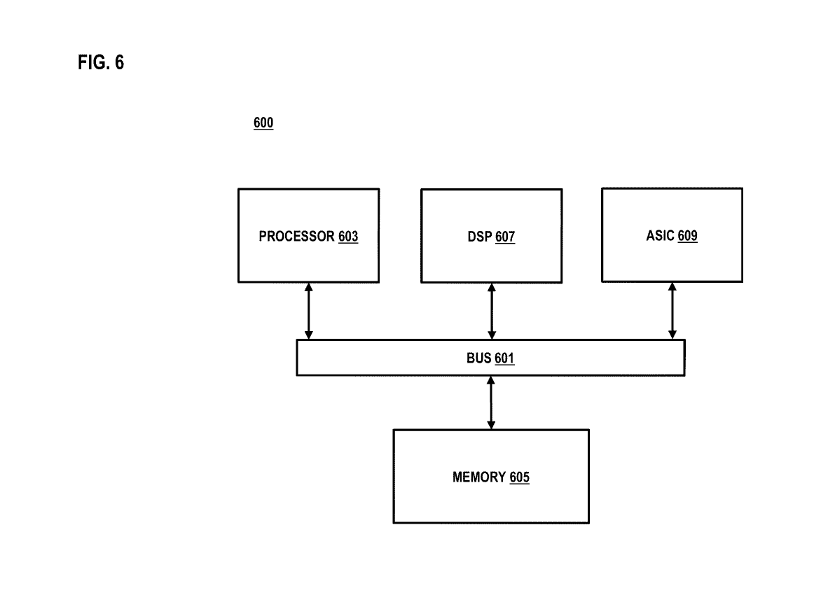

FIG. 6 illustrates a chip set or chip 600 upon which an embodiment of the invention may be implemented. Chip set 600 is programmed to dynamically adapt bandwidth consumption as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of dynamically adapting bandwidth consumption.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to dynamically adapt bandwidth consumption. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
assigning a unique token to a user, a node associated with the user, or a combination thereof based on a fulfilment of criterion established by a provider of a wireless access network;
determining at least one tier of service of a network provider to associate with a request for the use of bandwidth of the wireless access network based on the assignment; and
generating, in real-time, an instruction to adapt the amount of bandwidth to be shared by the node associated with the user based on the determination.

2. A method of claim 1, further comprising:
transmitting the instruction to the node associated with the user,
wherein the node is a network access point, or a network gateway of the provider of the wireless access network.

3. A method of claim 1, further comprising:
receiving, from the provider of the wireless access network, data for specifying an action performed by the user, the node associated with the user or a combination thereof; and
analyzing the data to determine whether the action fulfils the criterion,
wherein the assigning of the token is based on the analysis.

4. A method of claim 3, wherein the data is generated by a point-of-sales system, a billing system, a vendor system or a combination thereof associated with the provider of the wireless access network.

5. A method of claim 3, wherein the criterion includes transaction information, user information, product information, business rules, a service agreement or a combination thereof.

6. A method of claim 1, further comprising:
generating a message for specifying an incentive, an amount of bandwidth, a recommendation or a combination thereof to be associated with the user, the node associated with the user, or a combination thereof based on the fulfillment of the criterion,
wherein the node is a mobile device.

7. A method of claim 1, further comprising:
receiving a request for the use of bandwidth,
wherein the request specifies the at least one token, context information associated with the node associated with the user, or a combination thereof.

8. A method of claim 7, wherein the assigning of the token includes transmitting the token to the mobile device, presenting the token to the user or a combination thereof.

9. A method of claim 1, further comprising:
associating a period of validity to the token based on the fulfilment of the criterion,
wherein the token is active for the period of validity.

10. A method of claim 1, wherein the adapting of the amount of bandwidth is limited to only the user, the node associated with the user or a combination thereof.

11. An apparatus comprising:
at least one processor; and
at least one memory including computer program code for one or more programs,
the at least one memory and the computer program code configured to, with the at least one processor, cause the apparatus to perform at least the following,
assign a unique token to a user, a node associated with the user, or a combination thereof based on the fulfilment of criterion established by a provider of a wireless access network,
determine at least one tier of service of a network provider to associate with a request for the use of bandwidth of the wireless access network based on the assignment, and
generate, in real-time, an instruction to adapt the amount of bandwidth to be shared by the node associated with the user based on the determination.

12. An apparatus of claim 11, wherein the apparatus is further caused to:
transmit the instruction to the node associated with the user,
wherein the node is a network access point, or a network gateway of the provider of the wireless access network.

13. An apparatus of claim 11, wherein the apparatus is further caused to:
receive, from the provider of the wireless access network, data for specifying an action performed by the user, the node associated with the user or a combination thereof; and
analyze the data to determine whether the action fulfils the criterion,
wherein the assigning of the token is based on the analysis.

14. An apparatus of claim 13, wherein the data is generated by a point-of-sales system, a billing system, a vendor system or a combination thereof associated with the provider of the wireless access network.

15. An apparatus of claim 13, wherein the criterion includes transaction information, user information, product information, business rules, a service agreement or a combination thereof.

16. An apparatus of claim 11, wherein the apparatus is further caused to:
generate a message for specifying an incentive, an amount of bandwidth, a recommendation or a combination thereof to be associated with the user, the node associated with the user, or a combination thereof based on the fulfillment of the criterion,
wherein the node is a mobile device.

17. An apparatus of claim 11, wherein the apparatus is further caused to:
receive a request for the use of bandwidth,
wherein the request specifies the at least one token, context information associated with the node associated with the user, or a combination thereof.

18. An apparatus of claim 17, wherein the assigning of the token includes transmitting the token to the mobile device, presenting the token to the user or a combination thereof.

19. An apparatus of claim 11, further comprising:
associate a period of validity to the token based on the fulfilment of the criterion,
wherein the token is active for the period of validity.

20. An apparatus of claim 11, wherein the adapting of the amount of bandwidth is limited to only the user, the node associated with the user or a combination thereof.
